(19) United States
(12) Patent Application Publication
(10) Pub. No.: US 2008/0067114 A1
(43) Pub. Date: Mar. 20, 2008

(54) Separator card for mailpiece handling equipment

(75) Inventors: David P. Chastain, New Milford, CT (US); Allen L. Simers, Danbury, CT (US); Joshua A. Schriver, New Milford, CT (US); Jason W. Harbert, New Milford, CT (US); David W. Purcell, New Milford, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/522,717

(22) Filed: Sep. 18, 2006

(51) Int. Cl. B07C 5/00; B07C 5/344; G06K 9/00

(52) U.S. Cl. 209/552; 209/584; 209/571

(57) ABSTRACT

A system and method for separating batches of mail in a mailpiece sorter. The system employs a card stock interposed between batches of mail, which card stock includes a ferromagnetic symbology disposed on a face surface of the card stock. An inductive proximity detector is employed to scan the ferromagnetic symbology and produce a ferromagnetic signature signal indicative of the ferromagnetic parameters of the symbology. The system conveys batches of mail containing the card stock past the inductive proximity detector such that the signature signals may be read and compared to predefined ferromagnetic signature signals stored in a signal processor. The processor may then determine the beginning and/or ending of a mailpiece job run for use by the mailpiece sorter.

### TECHNICAL FIELD

This invention relates to systems for feeding mailpieces and, more particularly, to a new and useful device, system and method for separating batches of mailpieces to distinguish between mailpiece job runs.

### BACKGROUND ART

Mailpiece feeders are commonly employed in high-output mailpiece sorters demanding a steady, high-input flow of mailpieces for efficient operation. Therein, mailpieces are generally stacked in an up-right position, i.e., on-edge, on a transport deck and shuttled toward a take-out station where the mailpieces are singulated and sorted into one of a myriad of sorting bins/containers. Furthermore, two or more paddles or separator plates may be employed to define compartments therebetween to maintain the on-edge, vertical orientation of the juxtaposed mailpieces.

To distinguish between batches of mail to be sorted, e.g., different customers, it is common to employ a separator card to direct the sorter to begin or end a particular job. That is, when mailpieces are placed on a feeder deck, a separator card may be placed or inserted between batches of mail to provide information to the mailpiece sorter concerning the beginning or end of a particular mailpiece job run. For example, if a first set of bins or mailpiece containers are dedicated to a first customer, it is useful to know when a particular batch of customer mail has ended to divert the next batch to a second set of mailpiece containers. To optimize throughput, a sorter may incorporate various diverter mechanisms and paths to direct mail to various sortation bins/containers.

Separator cards of the prior art typically employ ferromagnetic material, e.g., a magnetic foil, bonded to or otherwise affixed to one or both sides of an underlying card stock or carrier material. Conventionally, the ferromagnetic material is a uniform layer or coating applied to the card stock such that the separator card may be interposed between mailpieces and be handled in much the same way as an individual mailpiece. That is, the separator card is configured similar to a typical flats-type mailpiece which may be loaded, singulated and sorted/out-sorted at the appropriate station or module. At a convenient location, typically when mailpieces are singulated at the end of the feeder deck, a detector interrogates the passing mailpieces, including, of course, any intervening cards, for a signature indicative of a ferromagnetic material. The sensed output signals of the inductive proximity detector are sent to and interpreted by a computer processor. The purpose thereof is for providing an indication that one mailpiece job run has ended and another has begun.

While such separator cards are used in a variety of mailpiece sorters and have been in operation for many years, it is not uncommon for erroneous signals to be issued when other ferromagnetic materials in the mailstream are sensed. For example, elements such as staples, paper clips or other binding devices can produce a “false positive” result, i.e., a separator card has been detected. While such false positives can produce a minor inconvenience when occurring infrequently, e.g., once daily, these errors can have significant adverse consequences when they occur on a more frequent basis, e.g., several or more times daily. That is, throughput is negatively impacted each time a sorter must be stopped to retrieve and resort mailpieces which have been inadvertently included in another batch of mail. Furthermore, should mailpieces of one batch be inadvertently intermixed with mailpieces of another, serious security consequences may result which may be difficult to assess.

A need, therefore, exists for a separator card which can be interpreted with a high degree of reliability to improve mailpiece handling efficiency and security.

### BRIEF DESCRIPTION OF THE DRAWINGS

The accompanying drawings illustrate presently preferred embodiments of the invention and, together with the general description given above and the detailed description given below, serve to explain the principles of the invention. As shown throughout the drawings, like reference numerals designate like or corresponding parts.

FIG. 1 is perspective view of a mailpiece feeder having a plurality of mailpieces disposed on a feeder deck, in which mailpieces are separated by one or more separator cards according to the present invention.

FIGS. 2a and 2b depict embodiments of a separator card according to the present invention having a linear pattern or array of ferromagnetic material (otherwise referred to as ferromagnetic symbology) imprinted or otherwise integrated on a face surface of the card.

FIG. 2c depicts another embodiment of the inventive separator card having a circular ferromagnetic symbology imprinted or otherwise integrated on a face surface of the card.

FIG. 3a is a perspective view of an inductive proximity detector for sensing a ferromagnetic signature produced by the ferromagnetic symbology.

FIG. 3b is a top view of the inductive proximity detector shown in FIG. 3a.

FIG. 4 is a flow diagram of the method steps for separating batches of mail according to the present invention for use in the mailpiece sorter.

The invention will be fully understood when reference is made to the following detailed description taken in conjunction with the accompanying drawings.

### SUMMARY OF THE INVENTION

A system and method is provided for separating batches of mail in a mailpiece sorter. The system employs a card stock interposed between batches of mail, which card stock includes a ferromagnetic symbology disposed on a face surface of the card stock. An inductive proximity detector is employed to scan the ferromagnetic symbology and produce a ferromagnetic signature signal indicative of the ferromagnetic parameters of the symbology. The system conveys batches of mail containing the card stock past the inductive proximity detector such that the signature signals may be read and compared to predefined ferromagnetic signature signals stored in a signal processor. The processor may then determine the beginning and/or ending of a mailpiece job run for use by the mailpiece sorter.

### DETAILED DESCRIPTION

A system and method is described for segregating mail or batches of mail using a separator card having properties which can be interpreted by a microprocessor. While separator cards of the prior art provided a minimum of information pertaining to when mail batches begin and end, the present invention provides an intelligent separator card which can provide a degree of security and certainty that mailpieces of one mail run are not inadvertently intermixed with mailpieces of another mail run.

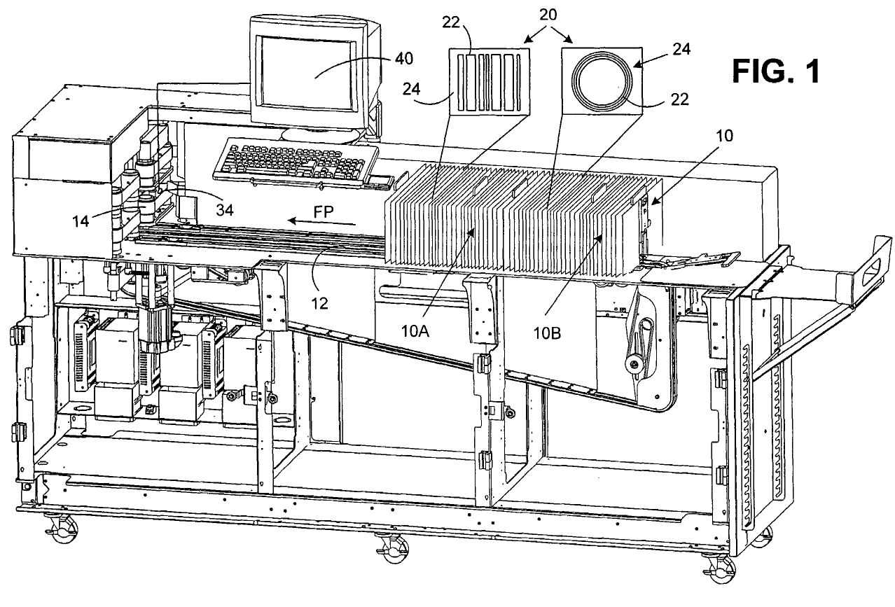

In FIG. 1, a plurality of mailpieces 10 are loaded onto the deck of a conveyor or feeder deck 12 for singulation by belts 14 disposed at one end of the deck 12. Several batches of mail 10 may be loaded to be sorted by a mailpiece sorter (not shown) in receipt of the singulated mailpieces conveyed along the feeder deck 12. Inasmuch as it is desirable to prevent the mailpieces 10A associated with one customer from being included or sorted with those mailpieces 10B of another customer, the mailpiece sorter must distinguish between job runs (i.e., the end of one job run from the beginning of another.)

The present invention provides a system and method for distinguishing between mailpiece job runs through the use of a novel separator card 20 capable of providing information unique to each customer or mailpiece job run. More specifically, the separator card 20 includes a unique pattern or symbology 22 printed or otherwise integrated with the face surface of the underlying card stock 24. The card stock 24 may be composed or fabricated from any of a variety of sheet material stock, such as paper, cardboard, plastic, composite material (fiber reinforced resin matrix material), etc.

The separator card 20 is interposed between batches of mailpieces 10A, 10B wherein it is desirable to have or use certain information to perform sorting operations. For example, one job run may require only a few mailpiece containers for sorting operations while others may require a multiplicity of containers to handle the volume of sorted mail. Furthermore, the frequency and speed of container replacement must be known to maximize throughput. Consequently, information concerning when a job run ends and another begins provides critical information to optimize sorting operations.

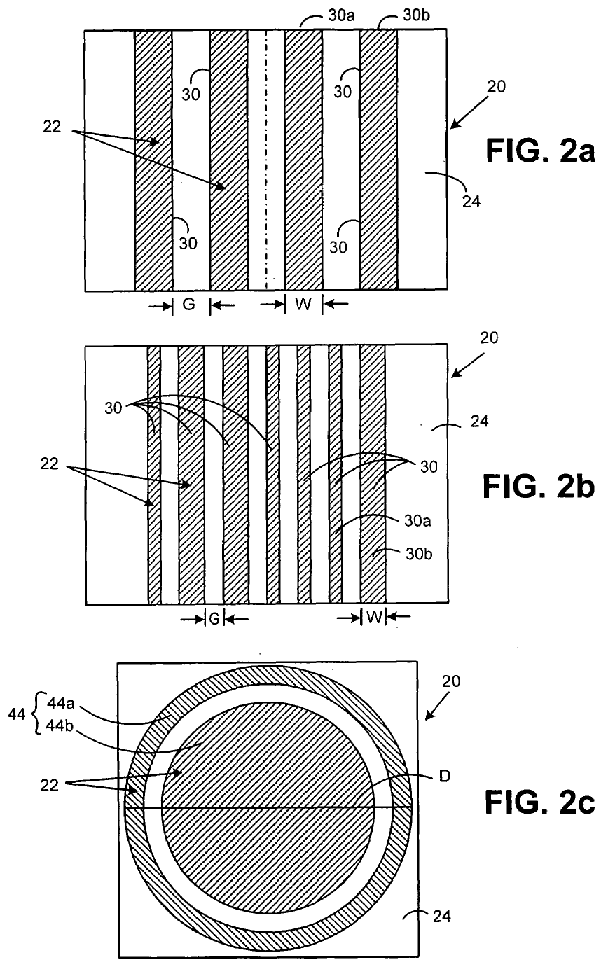

In FIGS. 2a and 2b, the ferromagnetic symbology 22 is configured based upon certain predetermined parameters which may be downloaded, compared and/or analyzed by a processor. In the context used herein, a “predetermined parameter” is any spatial relationship introduced by the pattern or magnetic property of the material. For example, the symbology 22 may include an array of linear bars 30 having a width dimension W and a gap dimension G between the bars 30. The bars 30 may vary in width dimension and vary in number from one separator card to another. Furthermore, the ferromagnetic properties may vary from one bar 30a to another bar 30b by varying the carbon content of the material.

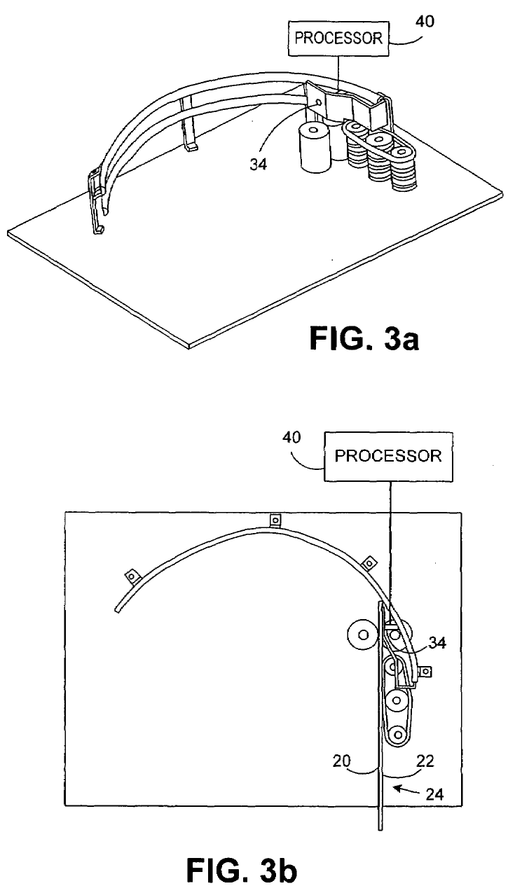

In FIGS. 1, 3a and 3b, an inductive proximity detector 34 is employed to sense the ferromagnetic signature produced by the symbology 22 as it is conveyed. More specifically, the inductive proximity detector 34 may be located downstream of the feeder deck 12 proximal to the singulation belts 36 thereof. That is, as the mailpieces 10 are individually singulated or separated for subsequent sortation, each of the mailpieces 10, including the separator cards 20, will pass the inductive proximity detector 34. As such, the inductive proximity detector 34 scans the job run and issues any ferromagnetic signature signals produced by the symbology 22 to a processor 40 for interpretation.

Stored in a database file of the processor 40 are predefined signature profiles which correspond to the ferromagnetic signatures produced by the separator card symbology 22. That is, by comparing the ferromagnetic signature signals produced by the symbology 22 to the predefined signature profiles stored in the processor 40, information may be extracted to perform a variety of mail sortation functions. In addition to providing information concerning the beginning and/or ending of a particular mail/job run, the separator card can, inter alia, associate a mail run with a particular customer and provide information concerning the type and number of containers to be employed.

In view of the vast variety of parameters which can be examined, i.e., the spacing, number, width and material properties of the ferromagnetic symbology, several parameters can be examined and cross-checked to ensure that a separator card 20 has been properly characterized and identified. To ensure that these same parameters are not misinterpreted, i.e., as a result of a card 20 being skewed relative to the inductive proximity detector 34, threshold tolerances can be incorporated to permit rotation or skewing of the separator card 20. For example, simple geometric/trigonometric relationships can be used (e.g., Pythagorean Theorem) to calculate the maximum tolerances or deviations which may develop should the linear bars rotate or skew through a certain angle.

To further simplify or prevent anomalies arising from rotation or skewing, in FIG. 2c, the separator card 20 may comprise a symbology 22 arranged to form a plurality of concentric circles 44. While many of the same parameters may be used to interpret the symbology, such as the number of circular rings 44a, 44b, the width of each and the spacing therebetween, it will be appreciated that skewing of the separator card will not impact these parameters. That is, as long as the inductive proximity detector scans along a diametrical line D of the rings 44a, 44b, skewing or rotation of the separator card 20 will not alter the geometric relationships established between the circular rings 44a, 44b.

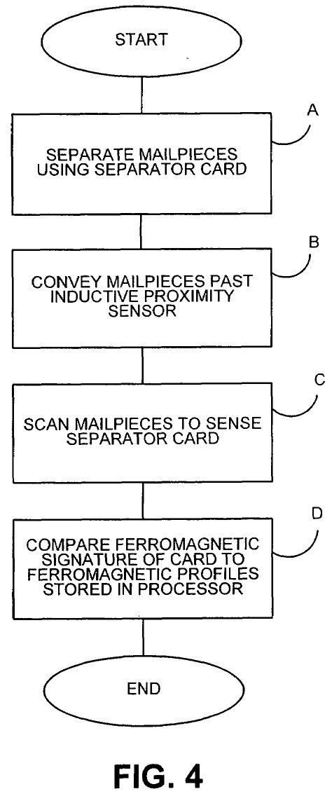

The method for segregating mailpieces using the separator cards can best be summarized by reference to the flow diagram of FIG. 4. In a first step A, separator cards 20 of the type described hereinabove, are interposed between batches of mailpieces 10 which may require special handling in terms of mail sortation. In step B, the mailpieces 10 along with the separator cards 20 are conveyed along a feeder deck and past an inductive proximity detector 34. In step C, the inductive proximity detector 34 scans the separator card 20 (typically as it is singulated from the remaining or other mailpieces 10) to generate the ferromagnetic signature signal of the symbology 22. In a final step D, the signature signal generated by the detector 34 is compared with the predefined ferromagnetic signature profiles stored in a processor to determine the beginning and/or ending of a mailpiece job run for use by the mailpiece sorter.

In summary, the separator card 20 of the present invention includes a ferromagnetic symbology 22 which can be interpreted by a processor 40 such that mail job runs can be processed with a high degree of reliability. Various symbology parameters can be employed to produce discernable information useable by the mail sortation or other handling equipment. Various parameters may be adapted, including linear or curvilinear patterns, to produce a variety of geometric and material properties. The patterns may be interpreted against a variety of profiles to ensure that job runs are properly identified and handled.

Although the invention has been described with respect to a preferred embodiment thereof, it will be understood by those skilled in the art that the foregoing and various other changes, omissions and deviations in the form and detail thereof may be made without departing from the scope of this invention.

What is claimed is:

1. A device for separating mailpieces in a mailpiece sorter, comprising:
card stock adapted to form a sheet;
a ferromagnetic symbology disposed on a face of the card stock, the symbology producing a ferromagnetic signature having certain predetermined parameters, the ferromagnetic signature readable by an inductive proximity detector for issuing an output signal indicative of the ferromagnetic signature,
the card stock in combination with the ferromagnetic symbology forming a separator card for insertion between mailpieces to separate one batch of mailpieces from another
wherein the output signal of the inductive proximity detector is compared to ferromagnetic signature profiles stored in a computer processor for determining information concerning the mailpiece job run for use by the mailpiece sorter

2. The device according to claim 1, wherein the ferromagnetic symbology defines a plurality of parallel bars each having a predefined width dimension.

3. The device according to claim 1, wherein the ferromagnetic symbology defines a plurality of parallel bars having a separation distance between adjacent parallel bars.

4. The device according to claim 1, wherein the ferromagnetic symbology defines a plurality of parallel bars each having a width dimension and a separation distance between adjacent parallel bars.

5. The device according to claim 1, wherein the ferromagnetic symbology defines a plurality of concentric circles each having a predefined width dimension.

6. The device according to claim 1, wherein the ferromagnetic symbology defines a plurality of concentric circles having a separation distance between adjacent circles.

7. The device according to claim 1, wherein the ferromagnetic symbology defines a plurality of concentric circles each having a predefined diameter dimension and a separation distance between adjacent circles.

8. A system for separating batches of mail in a mailpiece sorter, comprising:
card stock interposed between batches of mail, the card stock having a ferromagnetic symbology disposed on a face of the card stock, the symbology indicative of at least one parameter;
an inductive proximity detector operative to scan the ferromagnetic symbology on the card stock and to produce an output signal indicative of the at least one parameter;
a device for conveying the batches of mail past the inductive proximity detector, and
a processor having stored therein a plurality of predefined signature profiles each being indicative of stored information pertaining to a mailpiece job run, the processor, furthermore, responsive to the output signal of the inductive proximity detector for developing information concerning the mailpiece job run for use by the mailpiece sorter.

9. The system for separating batches of mail according to claim 8, wherein the ferromagnetic symbology defines a plurality of parallel bars having a predefined width dimension and wherein the at least one parameter is the sensed width dimension of the parallel bars.

10. The system for separating batches of mail according to claim 8, wherein the ferromagnetic symbology defines a plurality of parallel bars having a predefined width dimension and separation distance between the parallel bars and wherein the at least one parameter is the width dimension of the parallel bars and the separation distance between the parallel bars.

11. The system according to claim 8, wherein the ferromagnetic symbology defines a plurality of concentric circles each having a predefined width dimension.

12. The system according to claim 8, wherein the ferromagnetic symbology defines a plurality of concentric circles having a separation distance between adjacent circles.

13. The system according to claim 8, wherein the ferromagnetic symbology defines a plurality of concentric circles each having a predefined diameter dimension and a separation distance between adjacent circles.

14. A method for separating batches of mail in a mailpiece sorter, comprising the steps of:
interposing card stock between batches of mail, the card stock having a ferromagnetic symbology disposed on a face of the card stock, the symbology operative to produce a ferromagnetic signature indicative of at least one parameter;
conveying batches of mail containing the card stock past an inductive proximity detector;
scanning the ferromagnetic symbology on the card stock to produce a ferromagnetic signature signal indicative of the at least one parameter; and,
comparing the ferromagnetic signature signal of the ferromagnetic symbology with predefined ferromagnetic signature profiles stored in a processor to determine information concerning the mailpiece job run for use by the mailpiece sorter.

15. The method according to claim 14, wherein the ferromagnetic symbology defines a plurality of parallel bars having a predefined width dimension.

16. The method according to claim 14, wherein the ferromagnetic symbology defines a plurality of parallel bars having a predefined width dimension and separation distance between the parallel bars.

17. The method according to claim 14, wherein the ferromagnetic symbology defines a plurality of concentric circles each having a predefined width dimension.

18. The method according to claim 14, wherein the ferromagnetic symbology defines a plurality of concentric circles having a separation distance between adjacent circles.

19. The method according to claim 14, wherein the ferromagnetic symbology defines a plurality of concentric circles each having a predefined diameter dimension and a separation distance between adjacent circles.
